(19) United States
(12) Patent Application Publication
(10) Pub. No.: US 2025/0247670 A1
(43) Pub. Date: Jul. 31, 2025

(54) GEOLOCATION TRACKING FOR DATA PROCESSING SYSTEMS USING OUT-OF-BAND COMPONENTS

(71) Applicant: Dell Products L.P., Round Rock, TX (US)

(72) Inventors: ADOLFO SANDOR MONTERO, Pflugerville, TX (US); MOHIT ARORA, Frisco, TX (US); BASSEM EL-AZZAMI, Austin, TX (US); RAJARAVI CHANDRA KOLLARAPU, Allen, TX (US); VINODKUMAR VASUDEV OTTAR, Mckinney, TX (US); ABEYE TESHOME, Austin, TX (US); RICHARD M. TONRY, Gerogetown, TX (US); LUIS ANTONIO VALENCIA REYES, Waxahachie, TX (US)

(21) Appl. No.: 18/425,270

(22) Filed: Jan. 29, 2024

(51) Int. Cl. H04W 4/029; H04L 9/08

(52) U.S. Cl. CPC H04W 4/029; H04L 9/0822

(57) ABSTRACT

Methods and systems for managing operations of data processing system are disclosed. To manage operations of the data processing system, a management controller of the data processing system may obtain and provide validated location data in the form of a location report for the data processing system to an external device via an out-of-band communication channel. The validated location data may be used to verify whether the data processing system is following expected geographical routes. By identifying any inconsistencies between the validated location data and expected geographical locations, the likelihood of identifying potential unauthorized modifications or other forms of compromise of the data processing system may be increased.

### FIELD

Embodiments disclosed herein relate generally to managing a data processing system. More particularly, embodiments disclosed herein relate to systems and methods for managing operation of data processing systems based on location data using a management controller of the data processing systems.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1A shows a block diagram illustrating a system in accordance with an embodiment.

FIG. 1B shows a second block diagram illustrating a data processing system in accordance with an embodiment.

FIG. 2A shows an interaction diagram in accordance with an embodiment.

FIGS. 2B-2C show data flow diagrams illustrating a system over time in accordance with an embodiment.

FIGS. 2D-2E show an example implementation of geolocation tracking using out-of-band components in accordance with an embodiment.

FIG. 3 shows a flow diagram illustrating a method of managing a data processing system in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing a data processing system. The data processing system may provide computer-implemented services. Compromise of the data processing system (e.g., via malware infiltrating hardware components and/or software components of the data processing system) may cause the computer-implemented services to not be provided as desired by, for example, a downstream consumer of the computer-implemented services. Specifically, sensitive data stored by the data processing system may be accessed by an unauthorized entity, operation of the data processing system may be modified by the unauthorized entity, etc.

The data processing system may be vulnerable to compromise when transported (e.g., during various points in a stream of commerce and/or otherwise during the lifetime of the data processing system). For example, shipping delays may occur during transportation of the data processing system from a first geographical location to a second geographical location. During these delays, the data processing system may be compromised due to, for example, unauthorized transport of the data processing system to an unexpected physical location and injection of malware to a firmware component and/or hardware component of the data processing system.

To detect potential interference with the data processing system during vulnerable periods of time (such as during shipping), a geographical location of the data processing system may be catalogued over time to generate a location log for the data processing system. The location log may include location data for the data processing system indicating a physical location of the data processing system throughout a vulnerable period of time such as during shipping of the data processing system. The location log may then be compared to an expected path for the data processing system and if the data processing system does not follow the expected path (e.g., deviates by an amount exceeding a threshold), the data processing system may be considered as likely to be compromised.

However, the data processing system may, for various reasons, become unable to provide location data that is reliable (e.g., trustworthy, accurate, up to date, etc.). For example, hardware resources of the data processing system may become unpowered for periods of time, may be unable to connect to a communication network, and/or may become compromised by a malicious party (e.g., that may tamper with the location data). If reliable location data for the data processing system is unavailable, then the location log for the data processing system may also be unreliable.

Thus, to increase a likelihood of the data processing system generating reliable location data, location data for the data processing system may be managed using out-of-band methods. The location data may be generated and/or obtained using out-of-band components (and/or via out-of-band communication channels) that function independently from in-band components (e.g., hardware resources) of the data processing system. Consequently, if in-band components and/or in-band communication channels are compromised or non-operational, then the location data provided using out-of-band methods may remain available and reliable.

By doing so, embodiments disclosed herein may provide a system for managing (operation of) a data processing system based on verified location data of the data processing system. To do so, the data processing system may include out-of-band components such as a management controller. The management controller may, for example, obtain validated location data corresponding to different geographical locations of the data processing system during vulnerable periods of time (e.g., such as during shipping of the data processing system). The validated location data may be used to generate the location log which may indicate whether the data processing system was transported to an unexpected location during the vulnerable periods of time. Thus, the computer-implemented services may be more likely to be provided as desired to a downstream consumer of the computer-implemented services.

In an embodiment, a method for managing operations of a data processing system, the data processing system including hardware resources and a management controller that operates independently from the hardware resources, is provided. The method may include: obtaining a location log, by a management controller of the data processing system and via out-of-band communication channel of the data processing system, the location log indicating validated location data for the data processing system obtained over a period of time; generating a location report, by the management controller and using the location log, the location report indicating geographical locations at different points in time of the data processing system; and providing, by the management controller and via the out-of-band communication channel, the location report to an external device usable to verify whether the data processing system is following an expected path.

The external device may be a server capable of determining whether the data processing system is following an expected path of one or more expected paths, the expected path indicating a sequence of geographical locations and a duration of time over which the data processing system traverses the expected path to be considered normal.

The external device may be a user device that uses the location report to determine whether the geographical locations indicated by the location report are consistent with an external report generated by a user of the data processing system, the external report being considered normal.

Obtaining the location log may include: obtaining, by the management controller and via the out-of-band communication channel, the validated location data for the data processing system at different points in time; and generating the location log using the validated location data.

Obtaining the validated location data may include: obtaining, by the management controller and via the out-of-band communication channel, first location data for the data processing system; performing, by the management controller, a comparison process using the first location data and second location data to determine whether the first location data is consistent with the second location data, the second location data being a different type of data than the first location data; in a first instance of the comparison process in which the first location data is determined to be consistent with the second location data: obtaining, by the management controller and using at least a private key of a public private key pair, the validated location data based on the first location data and the second location data.

Performing the comparison process may include: obtaining, by the management controller and via the out-of-band communication channel, the second location data for the data processing system; and making a determination, based on the first location data and the second location data, regarding whether a difference between the first location data and the second location data falls within a threshold.

The method may also include: obtaining additional validated location data for the data processing system; updating the location log using the additional validated location data to obtain an updated location log; providing the updated location log to the external device to use for computer-implemented services.

The data processing system may include a network module adapted to separately advertise network endpoints for the management controller and hardware resources of the data processing system, the network endpoints being usable by a server to address communications to the hardware resources using an in-band communication channel and the management controller using the out-of-band communication channel.

The management controller and the network module may be on separate power domains from the hardware resources so that the management controller and the network module are operable while the hardware resources are inoperable.

The out-of-band communication channel may run through the network module, and an in-band communication channel that services the hardware resources may also run through the network module.

The network module may host a transmission control protocol/internet protocol (TCP/IP) stack to facilitate network communications via the out-of-band communication channel.

In an embodiment, a non-transitory media is provided that may include instructions that when executed by a processor cause the computer-implemented method to be performed.

In an embodiment, a data processing system is provided that may include the non-transitory media and a processor, and may perform the computer-implemented method when the computer instructions are executed by the processor.

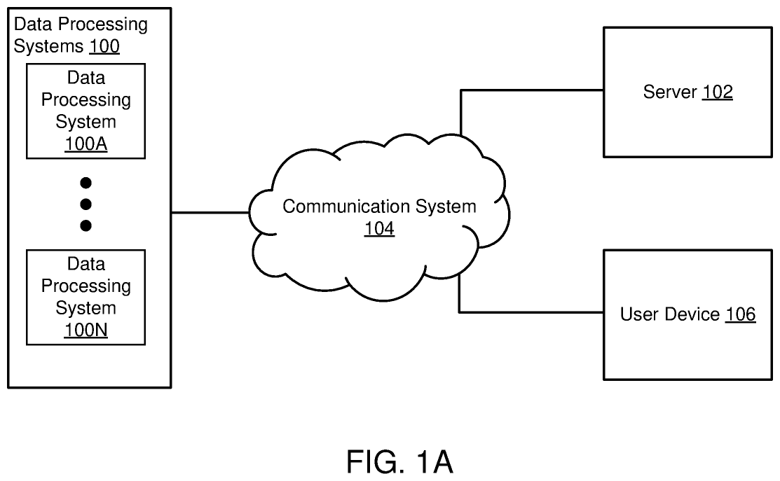

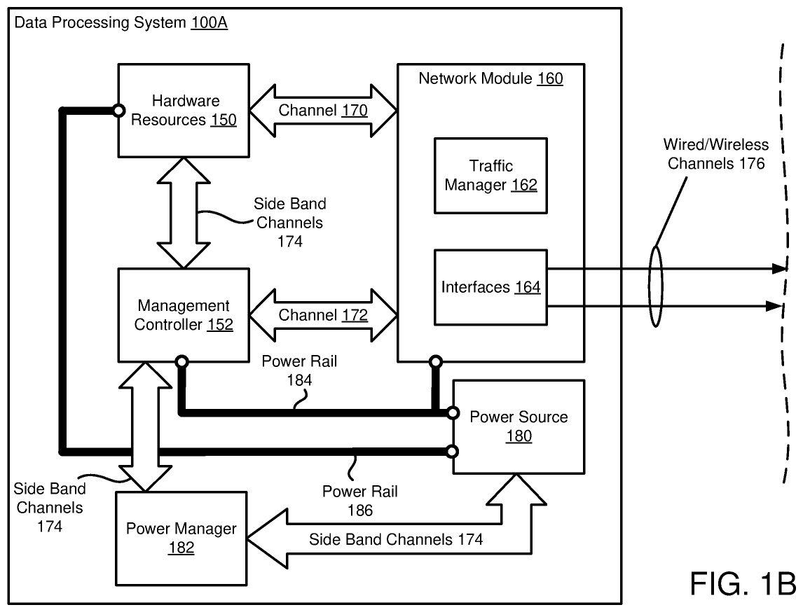

Turning to FIG. 1A, a block diagram illustrating a system in accordance with an embodiment is shown. The system shown in FIG. 1A may provide for management of data processing systems that may provide, at least in part, computer-implemented services. The system may include any number of data processing systems 100 (e.g., computing devices) that may each include any number of hardware components (e.g., processors, memory modules, storage devices, communications devices). The hardware components may support execution of any number and types of applications (e.g., software components). Changes in available functionalities of the hardware and/or software components may provide for various types of different computer-implemented services to be provided over time.

Operation of and/or computer-implemented services provided by a data processing system (e.g., data processing system 100A) may be negatively impacted if any unauthorized modifications (e.g., to hardware and/or software components of the data processing system) occur. For example, a manufacturer of data processing system 100A may provide a product warranty for data processing system 100A (e.g., for specific hardware components of data processing system 100A) in case of incidental failure or issues arising with operations of data processing system 100A. However, the manufacturer's product warranty may become ineffective if, for example, a hardware component such as a processor of data processing system 100A is replaced with another processor (e.g., not provided or authorized by the manufacturer).

Data processing systems 100 may be more vulnerable to unauthorized modifications (e.g., physical intrusions and/or other forms of compromise such as injection of malware) during, for example, transportation of data processing systems 100. Consider a scenario in which data processing system 100A has been purchased by a customer and is shipped from a first geographical location (e.g., a manufacturer's factory) to a second geographical location (e.g., the customer).

During shipment, data processing system 100A may be re-routed and/or intercepted from an expected shipping route to stop at an untrusted facility where a malicious third party may modify data processing system 100A (e.g., by replacing the manufacturer-approved hardware components of the data processing system with non-approved hardware components, injecting malicious software and/or firmware on the data processing systems, etc.). Data processing system 100A may resume its route to the customer and the customer may use data processing system 100A without knowledge of the interception to the shipping route. Doing so may lead to loss and/or manipulation of data stored by data processing system 100A, unintended use of data processing system 100A, computer-implemented services not being provided by data processing system 100A as desired, etc.

To identify unauthorized re-routing of data processing systems 100 during shipment, geographical locations of data processing systems 100 may be tracked during shipment (and/or during other vulnerable points in time) by an individual (e.g., shipping personnel such as a truck driver responsible for transporting a shipment of data processing systems) and/or by hardware components of the data processing systems during the shipment process. These forms of location tracking may be unreliable and/or untrustworthy, which may increase a likelihood of potential compromise of the data processing systems.

For example, the location data may be unreliable and/or untrustworthy when (i) the hardware components may become unpowered while the data processing system is in transit to a new location (e.g., unintentionally, or intentionally by a malicious party intending to conceal the new location of the data processing system), (ii) the hardware components may be compromised (e.g., by a malicious party intending to spoof the location), (iii) the hardware components may lack connection to a network used to establish in-band communication channels for transmitting location data to other devices, and/or (iv) the data processing system is otherwise unable to provide location data that accurately reflects the (current) location of the data processing system.

In general, embodiments disclosed herein may provide methods, systems, and/or devices for managing operation of a data processing system. The data processing system may include out-of-band components that may communicate with one another without traversing in-band communication channels and without utilizing in-band components. For example, the out-of-band components may manage location data for the data processing system and provide the location data to an external device to verify whether the data processing system is following an expected path. By doing so, potentially compromised or inoperable in-band components may be circumvented, decreasing the likelihood of the location data becoming compromised (e.g., unreliable) and/or increasing the likelihood of identifying any potential unauthorized modifications to data processing systems.

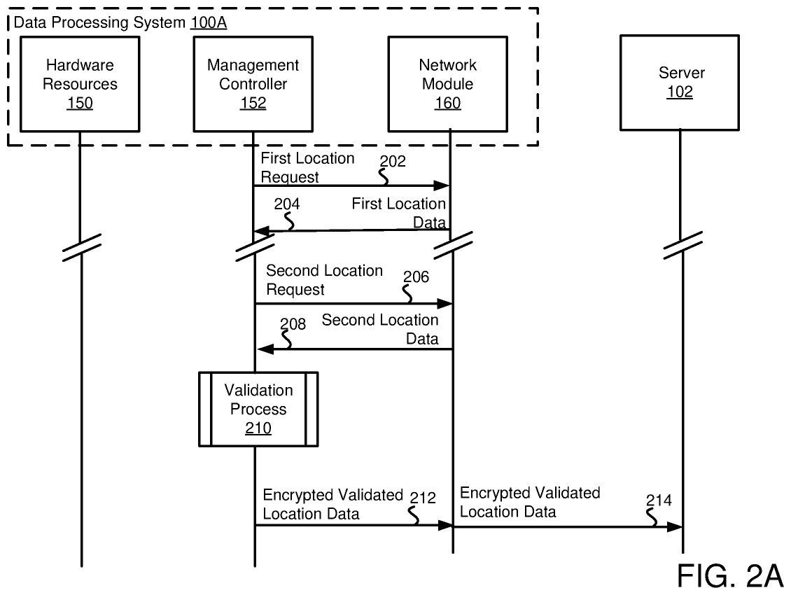

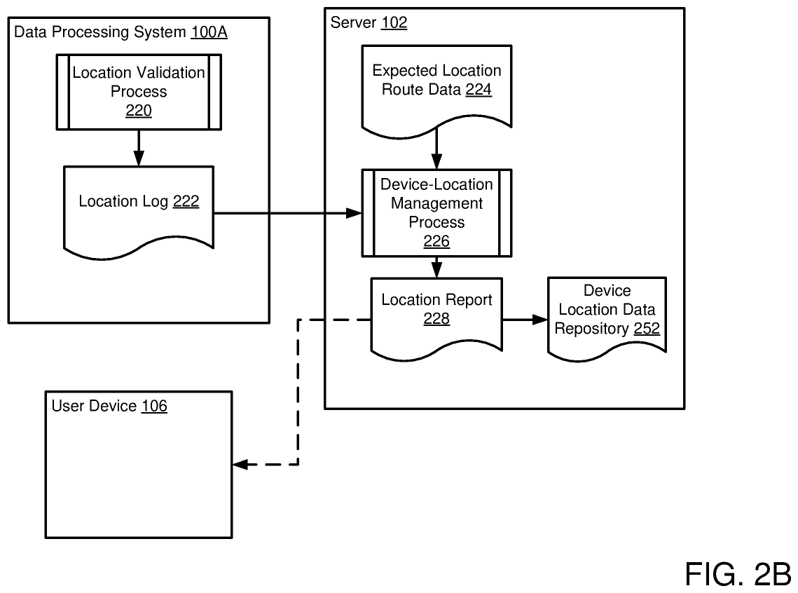

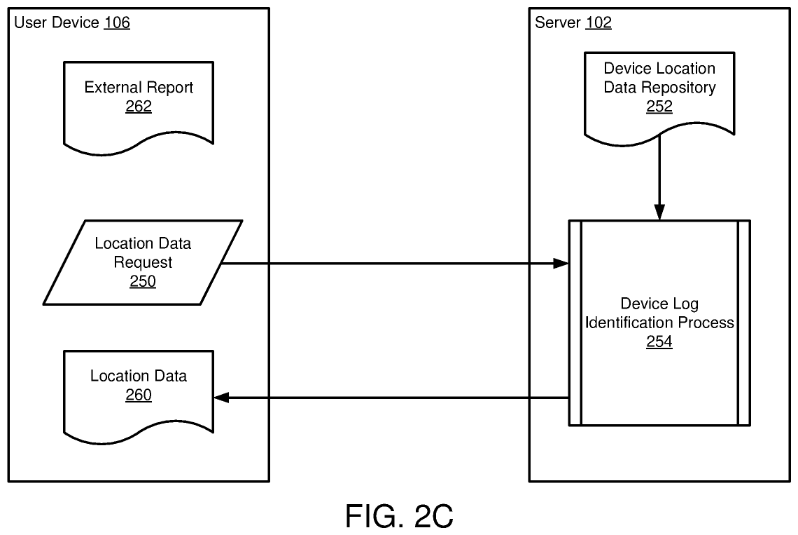

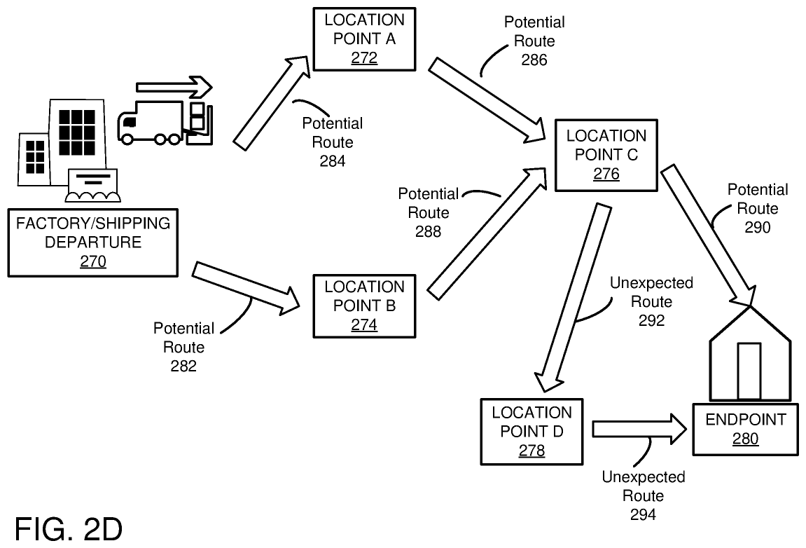

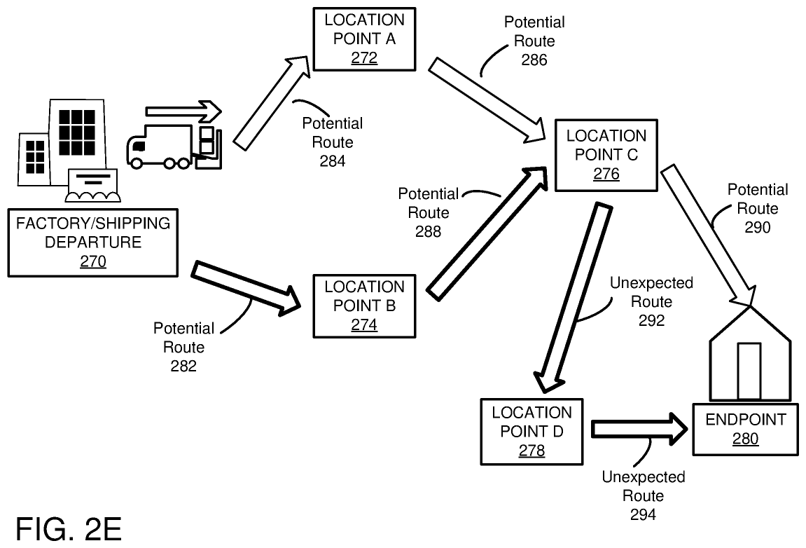

Therefore, out-of-band components may be used to generate a location report for a data processing system (e.g., 100A) as data processing system 100A is physically re-located (e.g., during shipping). To do so, validated location data may be obtained for the data processing system and the validated location data may be compiled to generate the location report. Refer to FIG. 2A for additional details regarding obtaining validated location data.

The location report may be provided to an external device (e.g., a server, a user device), the location report being usable to determine whether data processing system 100A followed the expected path during shipping. If data processing system 100A is determined to have followed the expected path, data processing system 100A may have a decreased likelihood of being compromised during transit.

To perform the above-mentioned functionality, the system of FIG. 1A may include data processing systems 100, user device 106 and/or server 102. Data processing systems 100, server 102, user device 106, and/or any other type of devices not shown in FIG. 1A may perform all, or a portion of the computer-implemented services independently and/or cooperatively. Each of these components is discussed below.

Data processing systems 100 may include any number and/or type of data processing systems (e.g., 100A-100N). Data processing systems 100 may provide computer-implemented services according to their physical location. To do so, data processing systems 100 may include out-of-band components (e.g., a network module, a management controller, etc.), and functionality that may allow data exchange between the out-of-band components independently from in-band components of data processing systems 100. For more information regarding out-of-band components of data processing systems 100, refer to the discussion of FIG. 1B.

For example, the out-of-band components of data processing systems 100 may (i) manage location data for data processing systems 100, (ii) determine, based on the location data, whether the location status of data processing systems 100 is reliable (e.g., via identifying inconsistencies among the location data for the data processing system), (iii) perform actions (e.g., of an action set) based on the determination of whether the location data is consistent that may update operation of data processing systems 100 and/or (iv) perform other actions relating to facilitating data processing systems 100 providing desired computer-implemented services.

Server 102 may include any number and/or type of servers (e.g., other data processing systems, management systems, storage devices, user devices, etc.) that may provide computer-implemented services, such as location-based services. To perform its functionality, server 102 may communicate (e.g., exchange data) with the out-of-band components of data processing systems 100 using out-of-band communication channels. For example, server 102 may provide location-based services for data processing system 100A via a management controller of data processing system 100A (e.g., bypassing any in-band components of data processing system 100A).

To provide location-based services, server 102 may, for example, (i) provide location status requests to the management controller (e.g., via out-of-band communication channels), (ii) participate in authentication processes (e.g., in order to verify authenticity of devices such as data processing systems 100), (iii) receive location data for data processing systems 100 (e.g., secured location reports from management controllers via out-of-band communication channels), and/or (iv) perform other actions that may facilitate location-based services to be provided by data processing systems 100. Refer to FIG. 2A for additional information regarding obtaining secured location reports.

User device 106 may also participate in the location-based services. When participating in the location-based services, user device 106 may (i) provide requests for location data of data processing system 100A, (ii) receive information regarding location data of the data processing system, and/or (iii) provide user input regarding any unauthorized locations identified based on expected location data and actual location data (e.g., reported by data processing system 100A).

Thus, the operation of data processing systems 100 may be managed using out-of-band methods (e.g., using out-of-band components and via out-of-band communication channels). By doing so, the location data may be more likely to be reliable, malicious activity and/or operating malfunctions may be more likely to be managed in a timely manner, and/or data processing systems 100 may be more likely to provide the desired computer-implemented services.

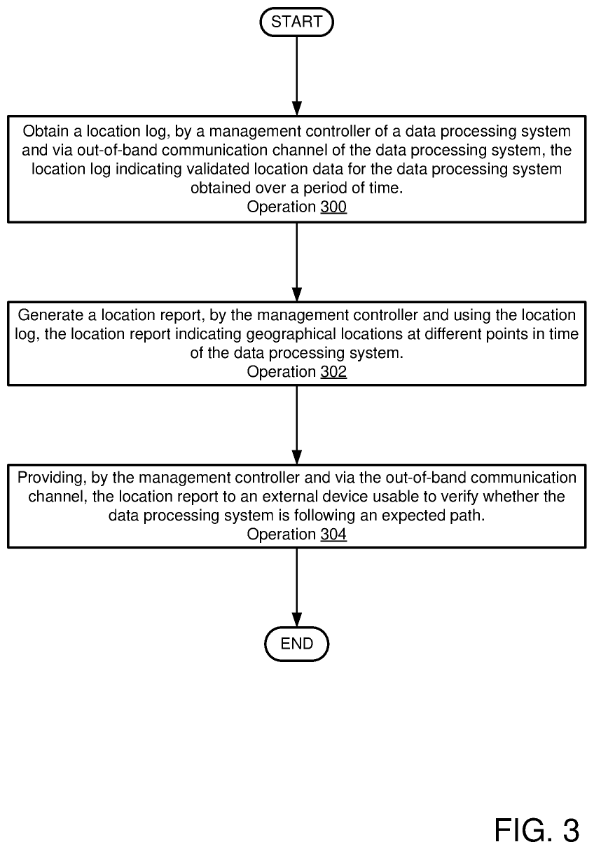

When providing their functionality, any of data processing systems 100, server 102, and/or user device 106 may perform all, or a portion of the methods shown in FIG. 3.

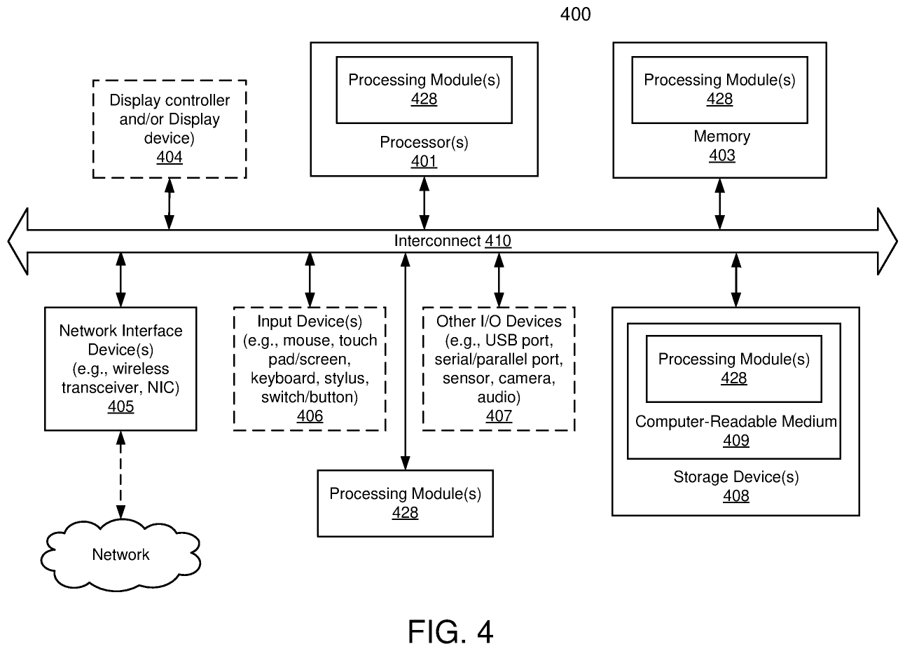

Any of (and/or components thereof) data processing systems 100, user device 106, and/or server 102 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., smartphone), an embedded system, local controllers, an edge node, and/or any other type of data processing device or system. For additional details regarding computing devices, refer to the discussion of FIG. 4.

In an embodiment, one or more of data processing systems 100, server 102, and/or user device 106 are implemented using an internet of things (IoT) device, which may include a computing device. The IoT device may operate in accordance with a communication model and/or management model known to data processing systems 100, user device 106, server 102, and/or other devices.

Any of the components illustrated in FIG. 1A may be operably connected to each other (and/or components not illustrated) with communication system 104. In an embodiment, communication system 104 includes one or more networks that facilitate communication between any number of components. The networks may include wired networks and/or wireless networks (e.g., and/or the Internet). The networks may operate in accordance with any number and/or types of communication protocols (e.g., such as the internet protocol). Communication system 104 may include any number of in-band communication channel and/or out-of-band communication channels.

While illustrated in FIG. 1A as including a limited number of specific components, a system in accordance with an embodiment may include fewer, additional, and/or different components than those illustrated therein. For example, while the system of FIG. 1A shows a single server (e.g., 102), it will be appreciated that the system may include any number of servers.

Turning to FIG. 1B, a diagram illustrating data processing system 100A in accordance with an embodiment is shown. Data processing system 100A may be similar to any of data processing systems 100 shown in FIG. 1A.

To provide computer-implemented services, data processing system 100A may include any quantity of hardware resources 150. Hardware resources 150 may be in-band hardware components, and may include a processor operably coupled to memory, storage, and/or other hardware components. Hardware resources 150 may (e.g., via the processor) provide the computer-implemented services desired by users of data processing system 100A.

The processor may host various management entities such as operating systems, drivers, network stacks, and/or other software entities that provide various management functionalities. For example, the operating system and drivers may provide abstracted access to various hardware resources.

To facilitate communication, hardware resources 150 may host a network stack that may facilitate packaging, transmission, routing, and/or other functions with respect to exchanging data with other devices. For example, the network stack may support transmission control protocol/internet protocol communication (TCP/IP) (e.g., the Internet protocol suite) thereby allowing the hardware resources 150 to communicate with other devices via packet switched networks and/or other types of communication networks.

The processor may also host various applications that provide the computer-implemented services. The applications may utilize various services provided by the management entities and use (at least indirectly) the network stack to communicate with other entities.

However, use of the network stack and the services provided by the management entities may place the applications at risk of indirect compromise. For example, if any of these entities trusted by the applications are compromised, these entities may subsequently compromise the operation of the applications. Additionally, if various drivers and/or the communication stack are compromised, communications to/from other devices may be compromised. If the applications trust these communications, then the applications may also be compromised.

For example, to communicate with other entities, an application may generate and send communications to a network stack and/or driver, which may subsequently transmit a packaged form of the communication via channel 170 to a communication component, which may then send the packaged communication (in a yet further packaged form, in some embodiments, with various layers of encapsulation being added depending on the network environment outside of data processing system 100A) to another device via any number of intermediate networks (e.g., via wired/wireless channels 176 that are part of the networks).

In addition, different configurations of hardware resources 150 and/or software resources may be implemented by data processing system 100A based on the type of computer-implemented services that are to be provided. Modifications to configurations of hardware resources 150 and/or the software resources may lead to downtime for data processing system 100A and may consume network bandwidth of channel 170.

To reduce the likelihood of the applications and/or other in-band entities from being indirectly compromised, data processing system 100A may include management controller 152 and network module 160. Each of these components of data processing system 100A is discussed below.

Management controller 152 may operate independently from hardware resources 150 and, therefore, hardware resources 150 may not host and/or manage operation of management controller 152. In addition, management controller 152 may be distinct from hardware resources 150 and, therefore, may be physically separate from hardware resources 150. Management controller 152 may also be operably connected to communication components of data processing system 100A via separate channels (e.g., 172) from the in-band components.

Management controller 152 may be implemented, for example, using a system on a chip or other type of independently operating computing device (e.g., independent from the in-band components, such as hardware resources 150, of a host data processing system 100A). Management controller 152 may provide various management functionalities for data processing system 100A. For example, management controller 152 may monitor various ongoing processes performed by the in-band component, may manage power distribution, thermal management, and/or other functions of data processing system 100A.

To do so, management controller 152 may be operably connected to various components via side band channels 174 (in FIG. 1B, a limited number of side band channels are included for illustrative purposes, it will be appreciated that management controller 152 may communication with other components via any number of side band channels). The side band channels may be implemented using separate physical channels, and/or with a logical channel overlay over existing physical channels (e.g., logical division of in-band channels). The side band channels may allow management controller 152 to interface with other components and implement various management functionalities such as, for example, general data retrieval (e.g., to snoop ongoing processes), telemetry data retrieval (e.g., to identify a health condition/other state of another component), function activation (e.g., sending instructions that cause the receiving component to perform various actions such as displaying data, adding data to memory, causing various processes to be performed), and/or other types of management functionalities.

For example, to reduce the likelihood of indirect compromise of an application hosted by hardware resources 150, management controller 152 may enable information from other devices to be provided to the application without traversing the network stack and/or management entities of hardware resources 150. To do so, the other devices may direct communications including the information to management controller 152. Management controller 152 may then, for example, send the information via side band channels 174 to hardware resources 150 (e.g., to store it in a memory location accessible by the application, such as a shared memory location, a mailbox architecture, or other type of memory-based communication system) to provide it to the application. Thus, the application may receive and act on the information without the information passing through potentially compromised entities. Consequently, the information may be less likely to also be compromised, thereby reducing the possibility of the application becoming indirectly compromised. Similar processes may be used to facilitate outbound communications from the applications.

Information provided to the application by management controller 152 may include, for example, instructions for implementation of computer-implemented services desired by users of data processing system 100A.

To facilitate communication with other devices, data processing system 100A may include network module 160. Network module 160 may provide communication services for in-band components and out-of-band components (e.g., management controller 152) of data processing system.

To provide the above-described functionalities, network module 160 may include traffic manager 162, interfaces 164, and may host an instance of a TCP/IP stack to facilitate communication with other devices independently of any of the in-band components (e.g., does not rely on any hosted software, hardware components, etc.). Accordingly, compromise of any of hardware resources 150 and hosted component may not result in indirect compromise of network module 160, management controller 152, and entities hosted by management controller 152.

Management controller 152 may be operably connected to communication components of data processing system 100A via separate channels (e.g., 172) from the in-band components, and may implement or otherwise utilize a distinct and independent network stack (e.g., TCP/IP). Consequently, management controller 152 may communicate with other devices independently of any of the in-band components (e.g., does not rely on any hosted software, hardware components, etc.). Accordingly, compromise of any of hardware resources 150 and hosted component may not result in indirect compromise of any management controller 152, and entities hosted by management controller 152.

To facilitate communication with other devices, data processing system 100A may include network module 160. Network module 160 may provide communication services for in-band components and out-of-band components (e.g., management controller 152) of data processing system 100A. To do so, network module 160 may include traffic manager 162 and interfaces 164.

Traffic manager 162 may include functionality to (i) discriminate traffic directed to various network endpoints advertised by data processing system 100, and (ii) forward the traffic to/from the entities associated with the different network endpoints. For example, to facilitate communications with other devices, network module 160 may advertise different network endpoints (e.g., different media access control address/internet protocol addresses) for the in-band components and out-of-band components. Thus, other entities may address communications to these different network endpoints. When such communications are received by network module 160, traffic manager 162 may discriminate and direct the communications accordingly (e.g., over channel 170 or channel 172, in the example shown in FIG. 1B, it will be appreciated that network module 160 may discriminate traffic directed to any number of data units and direct it accordingly over any number of channels).

Accordingly, traffic directed to management controller 152 may never flow through any of the in-band components. Likewise, outbound traffic from the out-of-band component may never flow through the in-band components.

To support inbound and outbound traffic, network module 160 may include any number of interfaces 164. Interfaces 164 may be implemented using any number and type of communication devices which may each provide wired and/or wireless communication functionality. For example, interfaces 164 may include a wide area network card, a WiFi card, a wireless local area network card, a wired local area network card, an optical communication card, and/or other types of communication components. These components may support any number of wired/wireless channels 176.

Thus, from the perspective of an external device, the in-band components and out-of-band components of data processing system 100A may appear to be two independent network entities, that may independently addressable, and otherwise unrelated to one another.

Network module 160 may utilize the instance of the TCP/IP stack to allow hardware resources 150 and/or management controller 152 to communicate with other devices via packet switched networks and/or other types of communication networks.

To facilitate management of data processing system 100A over time, hardware resources 150, management controller 152 and/or network module 160 may be positioned in separately controllable power domains. By being positioned in these separately controllable power domains, different subsets of these components may remain powered while other subsets are unpowered.

For example, management controller 152 and network module 160 may remain powered while hardware resources 150 is unpowered. Consequently, management controller 152 may remain able to communication with other devices even while hardware resources 150 are inactive. Similarly, management controller 152 may perform various actions while hardware resources 150 are not powered and/or are otherwise inoperable, unable to cooperatively perform various process, are compromised, and/or are unavailable for other reasons.

To implement the separate power domains, data processing system 100A may include a power source (e.g., 180) that separately supplies power to power rails (e.g., 184, 186) that power the respective power domains. Power from the power source (e.g., a power supply, battery, etc.) may be selectively provided to the separate power rails to selectively power the different power domains. A power manager (e.g., 182) may manage power from power source 180 that is supplied to the power rails (e.g., by providing instructions via side band channels 174). Management controller 152 may cooperate with power manager 182 to manage supply of power to these power domains. Management controller 152 may communicate with power manager 182 via side band channels 174 and/or via other means.

In FIG. 1B, an example implementation of separate power domains using power rails 184-186 is shown. The power rails may be implemented using, for example, bus bars or other types of transmission elements capable of distributing electrical power. While not shown, it will be appreciated that the power domains may include various power management components (e.g., fuses, switches, etc.) to facilitate selective distribution of power within the power domains.

When providing its functionality, management controller 152 may perform all, or a portion, of the methods and operations described in FIG. 2A.

While illustrated in FIG. 1B with a limited number of specific components, a system may include additional, fewer, and/or different components without departing from embodiments disclosed herein.

To further clarify embodiments disclosed herein, an interaction diagram in accordance with an embodiment is shown in FIG. 2A. The interaction diagram may illustrate examples of how data may be obtained and used within the systems of FIGS. 1A-1B.

In the interaction diagram, processes performed by and interactions between components of a system in accordance with an embodiment are shown. In the diagram, components of the system are illustrated using a first set of shapes (e.g., 152, 160, etc.), located towards the top of each figure. Lines descend from these shapes. Processes performed by the components of the system are illustrated using a second set of shapes (e.g., 210) superimposed over these lines.

Interactions (e.g., communication, data transmissions, etc.) between the components of the system are illustrated using a third set of shapes (e.g., 202, 204, etc.) that extend between the lines. The third set of shapes may include lines terminating in one or two arrows. Lines terminating in a single arrow may indicate that one-way interactions (e.g., data transmission from a first component to a second component) occur, while lines terminating in two arrows may indicate that multi-way interactions (e.g., data transmission between two components) occur.

Generally, the processes and interactions are temporally ordered in an example order, with time increasing from the top to the bottom of each page. For example, the interaction labeled as 202 may occur prior to the interaction labeled as 204. However, it will be appreciated that the processes and interactions may be performed in different orders, any may be omitted, and other processes or interactions may be performed without departing from embodiments disclosed herein.

Some of the lines descending from the first set of shapes are interrupted with line breaks. The line breaks may indicate, for example, a passage of time (e.g., between interactions and/or processes occurring above the line break and below other interactions and/or processes occurring below the line break), during which activity and/or events may occur.

The processes shown in FIG. 2A may be performed by any entity shown in the systems of FIGS. 1A-1B (e.g., a device similar to one of data processing systems 100, a server similar to server 102, etc.) and/or another entity without departing from embodiments disclosed herein.

Turning to FIG. 2A, an interaction diagram in accordance with an embodiment is shown. The interaction diagram may illustrate processes and interactions that may occur during managing a data processing system. For example, data processing system 100A may include a portable device that may provide computer-implemented services. As discussed with respect to FIGS. 1A-1B, data processing system 100A may include hardware resources 150, management controller 152, and network module 160. Over time, network module 160 may obtain location data usable to obtain a physical location of data processing system 100A (e.g., via interactions with location generation sources). Management controller 152 may verify the location of data processing system 100A, which may include obtaining multiple types of location data (e.g., via different location generation sources) from network module 160.

At interaction 202, a first location request may be provided to network module 160 by management controller 152. For example, the first location request may be generated and provided to network module 160 via (i) transmission via a message, (ii) storing in a storage with subsequent retrieval by network module 160, (iii) via a publish-subscribe system where network module 160 subscribes to updates from management controller 152 thereby causing a copy of the first location request to be propagated to network module 160, and/or via other processes. By providing the first location request to network module 160, network module 160 may generate and/or otherwise obtain first location data for data processing system 100A in response to the first location request.

The first location request may prompt network module 160 to obtain first location data for data processing system 100A (e.g., using a wireless wide area network (WWAN) connection facilitated by interfaces 164 of network module 160). Network module 160 may obtain the first location data in response to the first location request, which may include location data (e.g., coordinates, timestamp information, etc.) indicating a recent or current physical location for data processing system 100A. The first location data may include a first type of location data obtained using, for example, global navigation satellite systems (e.g., global positioning system).

At interaction 204, the first location data may be provided to management controller 152 by network module 160. For example, the first location data may be generated and provided to management controller 152 via (i) transmission via a message, (ii) storing in a storage with subsequent retrieval by management controller 152, (iii) via a publish-subscribe system where management controller 152 subscribes to updates from network module 160 thereby causing a copy of the first location data to be propagated to management controller 152, and/or via other processes. The first location data may be provided to management controller 152 via an out-of-band communication channel similar to channel 172 described in FIG. 1B. By providing the first location data to management controller 152, management controller 152 may receive a first type of location data for data processing system 100A in order to perform verification processes.

In order to perform validation process 210, management controller 152 may utilize multiple types of location data (e.g., indicating location of data processing system 100A) obtained from different sources in order to verify the reliability and quality of the location data. For example, management controller 152 may provide a second location request for second location data obtained from a different location-service sources compared to first location data.

At interaction 206, the second location request may be provided to network module 160 by management controller 152. For example, the second location request may be generated and provided to network module 160 via (i) transmission via a message, (ii) storing in a storage with subsequent retrieval by network module 160, (iii) via a publish-subscribe system where network module 160 subscribes to updates from management controller 152 thereby causing a copy of the second location request to be propagated to network module 160, and/or via other processes. The second location request may be provided to network module 160 via an out-of-band communication channel similar to channel 172 described in FIG. 1B, via an in-band communication channel similar to channel 170 described in FIG. 1B, and/or via other methods. By providing the second location request to network module 160, network module 160 may provide location gathering services for the data processing system 100A.

The second location request may prompt network module 160 to generate second location data for data processing system 100A (e.g., using a wireless local area network “WLAN” connection facilitated by interfaces 164 of network module 160). Network module 160 may generate the second location data in response to the second location request, which may include location data (e.g., coordinates, timestamp information, etc.) indicating a recent or current physical location for data processing system 100A. The second location data may include a second type of location data obtained using, for example, network-based location systems (e.g., Wi-Fi, cell tower triangulation, etc.).

At interaction 208, the second location data may be provided to management controller 152 by network module 160. For example, the second location data may be generated and provided to management controller 152 via (i) transmission via a message, (ii) storing in a storage with subsequent retrieval by management controller 152, (iii) via a publish-subscribe system where management controller 152 subscribes to updates from network module 160 thereby causing a copy of the second location data to be propagated to management controller 152, and/or via other processes. The second location data may be provided to management controller 152 via an out-of-band communication channel similar to channel 172 described in FIG. 1B. By providing the second location data to management controller 152, management controller 152 may receive a second type of location data for data processing system 100A in order to perform verification processes (e.g., validation process 210).

Management controller 152 may initiate validation process 210 based on the first location data and the second location data. For example, management controller 152 may determine whether the first location data of data processing system 100A is consistent with the second location data of data processing system 100A.

During validation process 210, the first location data and the second location data may be subjected to any type of comparison process to determine whether the first location data is consistent with the second location data. For example, management controller 152 may obtain the first location data and the second location data via communication channels (e.g., out-of-band communication channels, a combination of in-band and out-of-band communication channels) of data processing system 100A and make a determination regarding whether a difference between the first location data and the second location data falls within a threshold. The threshold may be programmed or set by an external device, for example, an administrator or an owner of the data processing system, a manufacture of the data processing system, etc.

The resulting determination may indicate the first location data is consistent with the second location data when the difference between the first location data and the second location data falls within the threshold. If the first location data is consistent with the second location data, then management controller 152 may generate validated location data for the data processing system (e.g., 100A). The validated location data may include, for example, (i) identifying information (e.g., for data processing system 100A and/or a user thereof), (ii) location data (e.g., one or more of the types of the location data obtained via validation process 210) for data processing system 100A, (iii) authentication information (e.g., usable to authenticate the location data of data processing system 100A), and/or (iv) any other information usable for providing secured (e.g., encrypted via a private public key) location data for data processing system 100A.

The validated location data may be used to generate encrypted validated location data. To do so, management controller 152 may sign, using a private key of a public private key pair, the validated location data to obtain a cryptographically verifiable data structure.

At interaction 212, the encrypted validated location data may be provided by management controller 152 to network module 160 (e.g., via a side band communication channel) through (i) transmission via a message, (ii) storing in a storage with subsequent retrieval by network module 160, (iii) a publish-subscribe system where network module 160 subscribes to updates from management controller 152 thereby causing a copy of the encrypted validated location data to be propagated to network module 160, and/or (iv) other processes. The encryption location report may be provided to network module 160 via an out-of-band communication channel similar to channel 172 described in FIG. 1B. By providing the encrypted validated location data to network module 160 via the out-of-band communication channel, the likelihood that the validated location data (e.g., included in the encrypted validated location data) may be protected, for example, from being potentially modified by an external device or third party may be increased.

At interaction 214, the encrypted validated location data may be provided by network module 160 to server 102 (e.g., via an out-of-band communication channel) through (i) transmission via a message, (ii) storing in a storage with subsequent retrieval by server 102, (iii) a publish-subscribe system where server 102 subscribes to updates from network module 160 thereby causing a copy of the encrypted validated location data to be propagated to server 102, and/or (iv) other processes. By providing the encrypted validated location data to server 102, server 102 may manage location data for data processing system 100A in order to provide computer-implemented services.

While illustrated in FIG. 2A as including a single network module, it may be appreciated that data processing system 100A may include separate network modules that may be used by separate components of data processing system 100A. For example, out-of-band communications may be obtained by a first network module and in-band communications may be obtained by a second network module. The encrypted validated location data may be aggregated from these separate network modules, or they may come from one network module via the out-of-band communication channel.

Server 102 may complete validation process 210 by, for example, obtaining the encrypted validated location data, and performing actions indicated by instructions included in the encrypted validated location data that may update the validated location data and/or configuration settings of data processing system 100A. For example, server 102 may store the validated location data, the additional information related to the validated location data, and/or other information included in the validated location data. Server 102 may access the validated location data (and other stored information) during other processes that may be performed to improve accuracy of the validated location data of data processing system 100A when providing computer-implemented services.

Thus, as shown in the example of FIG. 2A, a data processing system may manage and/or verify its location data using out-of-band methods. For example, the location data may be generated and obtained from multiple geolocation sources (e.g., global navigation satellite system, cellular technology, etc.) via out-of-band communication channels. By avoiding in-band communication methods and using multiple location sources, the location data that may be reported to a server, for example, may be more likely to be reliable and trusted for use in managing the operation of the data processing system.

Any of the processes illustrated using the second set of shapes and interactions illustrated using the third set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes and interactions illustrated using the third set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the processes and interactions may be implemented using any type and number of data structures. The data structures may be implemented using, for example, tables, lists, linked lists, unstructured data, data bases, and/or other types of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIGS. 1A-2A may perform various methods to improve accuracy of location reporting of data processing systems using out-of-band communication methods. By using out-of-band communication methods to obtain and provide location data, the data processing systems may be more likely to provide secure and reliable computer-implemented services.

To further clarify embodiments disclosed herein, data flow diagrams in accordance with an embodiment are shown in FIGS. 2B-2C. In these diagrams, flows of data and processing of data are illustrated using different sets of shapes. A first set of shapes (e.g., 222, 224, etc.) is used to represent data structures and a second set of shapes (e.g., 220, 226, etc.) is used to represent processes performed using and/or that generate data.

Turning to FIG. 2B, a first data flow diagram illustrating a data processing system (e.g., 100A) interacting with a server (e.g., 102) in accordance with an embodiment is shown. The data flow diagram may illustrate a first method of obtaining location reports based on location data for a data processing system (e.g., 100A) following the processes described in FIG. 2A.

To do so, data processing system 100A may perform location validation process 220. During location validation process 220, data processing system 100A may obtain validated location data (e.g., for the data processing system) via interactions and processes similar to those described in FIG. 2A. The validated location data may be recorded and stored in a data structure such as location log 222, to provide to an external device (e.g., server 102, user 106, etc.). Refer to FIG. 2A for additional details regarding obtaining validated location data.

Location log 222 may include an identifier for the data processing system (e.g., 100A) usable to track, for example, locations of the data processing system over a period of time. Location log 222 may include, for example, (i) identifying information (e.g., for data processing system 100A and/or a user thereof), (ii) any amount of validated location data for (e.g., indicating a physical location of) data processing system 100A, (iii) authentication information (e.g., usable to authenticate data processing system 100A and/or a user), and/or (iv) any other information usable for identifying location history of data processing system 100A.

Location log 222 may include any type and quantity of validated location data for data processing system 100A over a period of time. For example, location log 222 may include a first entry indicating a geographical location (e.g., geographic coordinate measurements such as longitude and latitude) of data processing system 100A at a first point in time and/or may include a second entry indicating a sequence of geographical locations at different points in time of data processing system 100A.

Data processing system 100A may provide a copy of location log 222 to server 102. To do so, a management controller of data processing system 100A (e.g., similar to management controller 152 described in FIG. 1B) may provide the copy of location log 222 to server 102 via an out-of-band communication channel. Based on information included in location log 222 (e.g., identity of the data processing system 100A), server 102 may initiate device-location management process 226.

During device-location management process 226, server 102 may use information included in location log 222 to: (i) authenticate data processing system 100A and/or location log 222, (ii) identify inconsistencies between an expected location route (e.g., indicated by expected location route data 224) and an actual location route (e.g., indicated by location log 22). For example, expected location route data 224 may include a data structure indicating an expected route for data processing system 100A to follow during a transportation process (e.g., shipping). Data processing system 100A may be expected travel from a first location (e.g., point A) to a second location (e.g., point B) and the transport of data processing system 100A from point A to point B may be expected to occur over a certain period of time.

Expected location route data 224 may include location data for data processing systems 100 (e.g., multiple data processing systems), such as, various physical locations that a data processing system (e.g., 100A) is expected to be located (e.g., as determined by an administrator, manufacturer, third-party warranty provider, and/or user of the respective data processing system).

Expected location route data 224 may also provide a location-time schedule (e.g., location route) which may be previously determined (e.g., by a manufacturer of data processing system 100A, by a downstream user of data processing system 100A, etc.) and the location-time schedule may indicate durations of time expected for portions of expected location route data 224. For example, expected location route data may indicate that data processing system 100A is expected to travel from a first geographical location to a second geographical location in a certain amount of time (e.g., and/or within an acceptable range of times).

Expected location route data 224 may include any type and quantity of information regarding location-time data for data processing systems 100 (e.g., multiple data processing systems as shown in FIG. 1A) which may represent physical location routes that a data processing system is expected to traverse (e.g., as previously specified by an administrator of the data processing system, end user of the data processing system, etc.). For example, server 102 may store a local copy of expected location route data 224 for data processing system 100A.

Expected location route data 224 may be used in device-location management process 226 to identify whether data processing system 100A is traversing an expected path based on the physical location data (e.g., location log 222).

To identify inconsistencies between an expected location route (e.g., specified via expected location route data 224) and an actual physical location(s), device-location management process 226 may be performed. During device-location management process 226, server 102 may perform any type or quantity of analysis to compare location log 222 to information from expected location route data 224 to determine whether one or more physical locations of data processing system 100A is consistent with one or more expected locations of data processing system 100A while traversing a pre-determined route. Refer to FIGS. 2D-2E for an example of routes for shipping of a data processing system.

As a result of device-location management process 226, server 102 may obtain location report 228. Location report 228 may include any type and quantity of information regarding geographical location data of data processing system 100A and notifications of any unexpected geographical locations in which the data processing system 100A has traversed. Location report 228 may include a data structure containing a report or summarization of geographical locations in which data processing system 100A has been located at different points in time and if any of those geographical locations are outside the expected geographical locations in which the data processing system is expected to traverse.

Location report 228 may be utilized by an administrator of data processing system 100A, a user of data processing system 100A, etc. in order to manage the operation of data processing system 100A. For example, Location report 228 may be provided to user device 106 (e.g., operated by a user) once location report 228 is generated by server 102.

In addition, location report 228 may be locally stored by server 102 in a data repository, such as device location data repository 252, to be utilized by an administrator and/or user with authorized access to data stored by server 102.

Thus, as shown in the example of FIG. 2B, location data for a data processing system may be managed using out-of-band methods. For example, the location data may be obtained and provided (e.g., over time as it is obtained and/or after compiling any quantity of location data into a data structure) to an external device. By avoiding in-band methods, the location data may be more reliably used to identify potential compromise and/or otherwise unintended use of the data processing system.

Turning to FIG. 2C, a second data flow diagram illustrating a user device (e.g., 106) interacting with a server (e.g., 102) in accordance with an embodiment is shown. The data flow diagram may illustrate a second method of obtaining location data (e.g., similar to validated location data described in FIG. 2A and/or location report 228 described in FIG. 2B) based on location data for a data processing system (e.g., 100A) following the processes described in FIG. 2A.

A user (e.g., a customer that purchased data processing system 100A, a third-party warranty provider for data processing system 100A) may utilize user device 106 to request location data from server 102. The user may have previously generated an external report indicating expected geographical locations for data processing system 100A (e.g., external report 262) and may request location data from server 102 (and/or directly from data processing system 100A (not shown)) to compare the location data to external report 262. The location data may include any amount of validated location data and/or a location report (e.g., similar to location report 228 described in FIG. 2B). By doing so, the user may determine whether data processing system 100A was located in any unauthorized locations and/or whether any unexpected delays occurred during shipping of data processing system 100A to its destination (e.g., to the user).

To obtain location data for a data processing system (e.g., 100A), a requestor (e.g., user device 106) may send a request (e.g., location data request 250) to server 102. Location data request 250 may include information identifying the data processing system (e.g., 100A) in which the requested location data is regarding, and/or any other information necessary to obtain location data (e.g., location reports, validated location data) for a data processing system. For example, location data request 250 may include identifying information such as device identifier, product number, and/or other types of information regarding the data processing system for which the location data is being requested. Additionally, location data request 250 may include identifying information of the requesting device (e.g., user device 106) such as device identifiers, internet protocol “IP” address, etc. and/or any other information usable to identify the requestor.

Once obtained, server 102 may use information indicated by location data request 250 to perform device log identification process 254. Device log identification process 254 may include: (i) verifying that the requesting device (e.g., user device 106) has authorization to access location data of the requested data processing system, (ii) identifying the location data (e.g., validated location data, location reports) for the requested data processing system (e.g., data processing system 100A), and/or (iii) providing the location data to the requesting device (e.g., user device 106) which may include any of the aforementioned information.

For example, device log identification process 254 may include performing a look up process using device location data repository 252 and an identifier for data processing system 100A (e.g., obtained via location data request 250) as a key for the look up process. As a result of the look up process, a location report and/or any other location information relating to data processing system 100A that is stored in device location data repository 252 may be identified.

Device location data repository 252 may store any type and quantity of data regarding locations for data processing systems. To differentiate data regarding different data processing systems, device location data repository 252 may organize and store location data, for example, in a searchable table including rows corresponding to each data processing system in which location data has been obtained. Further, the rows may be keyed to facilitate efficient searching based on, for example, an identifier for each respective data processing system.

When obtained by device log identification process 254, location data 260 may be provided to the requesting device (e.g., user device 106). For example, server 102 may identify the location data for the requested data processing system and provide the location data to user device 106.

Location data 260 may include any type or quantity of information regarding geographical location data (e.g., validated location data, location reports) and/or any notifications of potentially unexpected geographical locations in which the data processing system has traversed (e.g., identified via device-location management process 226 described in FIG. 2B). Location data 260 may be used by a user or operator of user device 106 to initiate other actions to be performed in order to manage operations of the data processing system (e.g., 100A).

For example, location data 260 may include a location log similar to location log 222 generated in FIG. 2B. A user may utilize perform a process similar to device-location management process 226 described in FIG. 2B to compare an expected route indicated by external report 262 to a series of validated locations of data processing system 100A indicated by the location log (not shown). By doing so, the user may determine whether data processing system 100A was located in any unexpected locations and/or experienced any unexpected delays during shipping.

Thus, as shown in the example of FIG. 2C, location data for data processing systems may be obtained by a user or administrator of the respective data processing system in order to manage the operation of the data processing system.

To further clarify embodiments disclosed herein, an example implementation in accordance with an embodiment is shown in FIGS. 2D-2E. These figures show diagrams illustrating a geolocation management process that may reduce a likelihood of compromise of data processing systems and/or may improve shipping logistics for the data processing systems.

FIGS. 2D-2E show diagrams of example processes for identifying whether a data processing system is following an expected path. While described with respect to location management services, it will be understood that embodiments disclosed herein are broadly applicable to different use cases as well as different types of data processing systems than those described below.

Turning to FIG. 2D, consider a scenario in which a shipment includes data processing systems (e.g., personal computer devices in shipping packages). The data processing systems may collect validated location data (e.g., location points and corresponding points in time) for the data processing systems traversing from a manufacturer factory (e.g., factory/shipping departure 270) to a final destination (e.g., endpoint 280) and may provide the validated location data to a server (e.g., a computer operating system). The server (and/or other entity obtaining the validated location data such as a user) may store and analyze the validated location data in order to make decisions regarding whether the data processing systems are following an expected path.

During every segment of the shipment process, the data processing systems (e.g., of the shipment of data processing systems) may provide their geographical location data (e.g., the validated location data) to an external device using out-of-band communication methods. The geographical location data for the data processing systems may be provided to an external device as determined by, for example, the manufacturer or administrator of the data processing systems. For example, the geographical location data for the data processing systems may be obtained and provided to an external server based on a time-schedule (e.g., every hour for the duration of the shipping process, once at the end of the shipping process) using the out-of-band communication channel.

As shown in FIG. 2D, a shipment of data processing systems (e.g., similar to data processing system 100A), may be scheduled to depart from factory/shipping departure 270 (e.g., manufacturing site, third party shipping company, etc.) at 8:00 a.m. on a Monday and arrive at endpoint 280 (e.g., final destination point) by Wednesday at 6:00 p.m. The potential routes may include various expected or normal paths that the data processing systems may follow traversing from the start point (e.g., factory/shipping departure 270) to a stop point (e.g., endpoint 280). For example, the shipment of data processing systems may depart factory/shipping departure 270 and traverse either potential route 282 or potential route 284 to arrive at the respective location points, location point A 272 or location point B 274.

Once the shipment reaches either location point A 272 or location point B 274, the shipment may traverse either potential route 286 or potential route 288 in order to reach location point C 276 as expected. Once the shipment reaches location point C 276, the data processing system may have other potential routes in which may be considered expected or normal based on the expected shipping routes.

One expected route following arrival of the shipment at location point C 276 may be potential route 290 to arrive at endpoint 280. As shown in FIG. 2D, other routes including unexpected route 292 may be unexpected and may not be included in any expected shipment route for the data processing systems.

Turning to FIG. 2E, consider a first example in which the shipment of data processing systems may be scheduled to travel from a manufacturer's factory (e.g., factory/shipping departure 270) to be delivered at a distribution company (e.g., endpoint 280). The data processing systems (e.g., OF the shipment of data processing systems) may obtain physical location data of the data processing systems consistently throughout traversing from factory/shipping departure 270 to endpoint 280 and provide the physical location data to an external device (e.g., server 102 as illustrated and described in FIG. 2A). The data processing systems may provide the physical location data, for example, via a location log (e.g., as described in FIG. 2B) to the external device (e.g., server 102 shown in FIG. 2B) either periodically while in transit to endpoint 280 and/or concurrently once the data processing systems have reached the final shipping destination (e.g., endpoint 280).

The shipment of data processing systems may traverse from location point C 276 to location point D 278 (e.g., via unexpected route 292). Unexpected route 292 may indicate that the shipment of data processing systems is potentially compromised since unexpected route 292 does not align with any of the expected or potential routes (e.g., potential route 290), after departing location point C 276.

Thus, as illustrated in FIG. 2E, when the shipment of data processing systems follows an unexpected route or its physical location does not match an expected route, a notification of the unexpected route or location may be generated along with the location log of the data processing systems and provided to an external system.

FIG. 3 illustrates a method that may be performed by the components of the system of FIGS. 1A-2C. In the diagram discussed below and shown in FIG. 3, any of the operations may be repeated, performed in different orders, and/or performed in parallel with or in a partially overlapping in a timely manner with other operations. The method described with respect to FIG. 3 may be performed by a data processing system, any component of a data processing system (e.g., a management controller, hardware resources, a network module), a server, a user device, and/or another device.

Turning to FIG. 3, a flow diagram illustrating a method of managing operations of a data processing system in accordance with an embodiment is shown. The method may be performed, for example, by a data processing system, a management system, a communication system, a management controller, hardware resources, and/or other components illustrated in FIGS. 1A-2E.

At operation 300, a location log may be obtained. The location log may be obtained via an out-of-band communication channel using methods described with respect to FIGS. 2A-2B and/or by other out-of-band communication methods. For example, to avoid using any potentially unavailable hardware resources (e.g., in-band components) of the data processing system, the location log may be obtained by a management controller of the data processing system and/or may be provided (e.g., transmitted) to the network module via the out-of-band communication channel. The location log may indicate validated location data for the data processing system obtained over a period of time.

Obtaining the location log may include (i) obtaining validated location data for the data processing system at different points in time, and/or (ii) generating the location log using the validated location data. The validated location data may be obtained by (i) obtaining first location data for the data processing system, (ii) performing a comparison process using the first location data and second location data to determine whether the first location data is consistent with the second location data, (iii) in a first instance of the comparison process in which the first location data is determined to be consistent with the second location data, obtaining the validated location data based on the first location data and the second location data, and/or (iv) by any other methods.

The first location data may be obtained via out-of-band communication channel using methods described with respect to FIG. 2A and/or by other out-of-band communication methods. For example, to avoid using any potentially unavailable hardware resources (e.g., in-band components) of the data processing system, the first location data may be obtained by a network module of the data processing system and/or may be provided (e.g., transmitted) to the management controller via the out-of-band communication channel.

Performing the comparison process may include: (i) obtaining the second location data for the data processing system, and (ii) making a determination, based on the first location data and the second location data, regarding whether a difference between the first location data and the second location data falls within a threshold. For example, the first location data may be consistent with the second location data when the difference between the first location data and the second location data falls within the threshold.

The second location data for the data processing system may be obtained by receiving the second location data via out-of-band communication channel. For example, a network module of the data processing system may provide the second location data to the management controller (e.g., of the data processing system) via electronic communication using the out-of-band communication channel.

The determination may be facilitated by (i) obtaining the threshold indicating an acceptable range for the different between the first location data and the second location data in order for the first location data to be consistent with the second location data, (ii) obtaining a difference between the first location data and the second location data, and (iii) comparing the difference between the first location data and the second location data to the threshold to identify whether the first location data is consistent with the second location data.

The validated location data may be obtained by the management controller and using at least a private key of a public private key pair therefore increasing the security of the validated location data, for example, from being modified by an unauthorized user. For example, the validated location data may be obtained by signing, using the private key, a data package comprising at least the first location data to generate the validated location data.

At operation 302, a location report may be generated. The location report may be generated by the management controller (e.g., an application or other piece of software hosted by the management controller may generate the location report) and using the location log (e.g., validated location data for the data processing system). The location report may indicate geographical locations at different points in time of the data processing system. For example, the management controller of the data processing system may generate the location log by compiling the validated location data into a data structure specifying geographical locations of the data processing system.

At operation 304, the location report may be provided to an external device usable to verify whether the data processing system is following an expected path. The location report may be provided to an external device via electronic transmission using the out-of-band communication channel and/or other out-of-band communication methods. For example, the management controller may send the location report to a user device using the out-of-band communication channel.

The method may further include (i) obtaining additional validated location for the data processing system, (ii) updating the location log using the additional validated location data to obtain an updated location log, and/or (iii) providing the updated location log to the external device to use for computer-implemented services. Obtaining additional validated location data, updating the location log and providing the updated location log to the external device may be facilitated in similar methods as described above in operations 300-304.

The method may end following operation 304.

Using the methods illustrated in FIG. 3, embodiments disclosed herein may provide systems and methods usable to manage data processing systems by providing location reports (e.g., including validated location data for the data processing system) to an external device (e.g., via out-of-band communication methods) to verify the data processing system is following an expected path (e.g., based on predetermined geographical locations in which the data processing system may traverse). By managing the location data without relying on in-band communication methods, the likelihood of the location reports being modified, leaked, and/or otherwise compromised may be reduced and the likelihood of providing consistent location status of data processing systems may be increased. By providing consistent location status of data processing systems, computer-implemented services provided by the data processing systems may be more likely to be desirable.

Any of the components illustrated in FIGS. 1A-2E may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing operations of a data processing system, the data processing system comprising hardware resources and a management controller that operates independently from the hardware resources, the method comprising:
obtaining a location log, by a management controller of the data processing system and via out-of-band communication channel of the data processing system, the location log indicating validated location data for the data processing system obtained over a period of time;
generating a location report, by the management controller and using the location log, the location report indicating geographical locations at different points in time of the data processing system; and
providing, by the management controller and via the out-of-band communication channel, the location report to an external device usable to verify whether the data processing system is following an expected path.

2. The method of claim 1, wherein the external device is a server capable of determining whether the data processing system is following an expected path of one or more expected paths, the expected path indicating a sequence of geographical locations and a duration of time over which the data processing system traverses the expected path to be considered normal.

3. The method of claim 1, wherein the external device is a user device that uses the location report to determine whether the geographical locations indicated by the location report are consistent with an external report generated by a user of the data processing system, the external report being considered normal.

4. The method of claim 3, wherein obtaining the location log comprises:
obtaining, by the management controller and via the out-of-band communication channel, the validated location data for the data processing system at different points in time; and
generating the location log using the validated location data.

5. The method of claim 4, wherein obtaining the validated location data comprises:
obtaining, by the management controller and via the out-of-band communication channel, first location data for the data processing system;
performing, by the management controller, a comparison process using the first location data and second location data to determine whether the first location data is consistent with the second location data, the second location data being a different type of data than the first location data;
in a first instance of the comparison process in which the first location data is determined to be consistent with the second location data:
obtaining, by the management controller and using at least a private key of a public private key pair, the validated location data based on the first location data and the second location data.

6. The method of claim 5, wherein performing the comparison process comprises:
obtaining, by the management controller and via the out-of-band communication channel, the second location data for the data processing system; and
making a determination, based on the first location data and the second location data, regarding whether a difference between the first location data and the second location data falls within a threshold.

7. The method of claim 1, further comprising:
obtaining additional validated location data for the data processing system;
updating the location log using the additional validated location data to obtain an updated location log;
providing the updated location log to the external device to use for computer-implemented services.

8. The method of claim 1, wherein the data processing system comprises a network module adapted to separately advertise network endpoints for the management controller and hardware resources of the data processing system, the network endpoints being usable by a server to address communications to the hardware resources using an in-band communication channel and the management controller using the out-of-band communication channel.

9. The method of claim 8, wherein the management controller and the network module are on separate power domains from the hardware resources so that the management controller and the network module are operable while the hardware resources are inoperable.

10. The method of claim 8, wherein the out-of-band communication channel runs through the network module, and an in-band communication channel that services the hardware resources also runs through the network module.

11. The method of claim 8, wherein the network module hosts a transmission control protocol/internet protocol (TCP/IP) stack to facilitate network communications via the out-of-band communication channel.

12. A non-transitory machine-readable medium having instructions stored therein, which when executed by a processor, cause the processor to perform operations for managing operations of a data processing system, the data processing system comprising hardware resources and a management controller that operates independently from the hardware resources and the operations comprising:
obtaining a location log, by a management controller of the data processing system and via out-of-band communication channel of the data processing system, the location log indicating validated location data for the data processing system obtained over a period of time;
generating a location report, by the management controller and using the location log, the location report indicating geographical locations at different points in time of the data processing system; and
providing, by the management controller and via the out-of-band communication channel, the location report to an external device usable to verify whether the data processing system is following an expected path.

13. The non-transitory machine-readable medium of claim 12, wherein the external device is a server capable of determining whether the data processing system is following an expected path of one or more expected paths, the expected path indicating a sequence of geographical locations and a duration of time over which the data processing system traverses the expected path to be considered normal.

14. The non-transitory machine-readable medium of claim 12, wherein the external device is a user device that uses the location report to determine whether the geographical locations indicated by the location report are consistent with an external report generated by a user of the data processing system, the external report being considered normal.

15. The non-transitory machine-readable medium of claim 14, wherein obtaining the location log comprises:
obtaining, by the management controller and via the out-of-band communication channel, the validated location data for the data processing system at different points in time; and
generating the location log using the validated location data.

16. The non-transitory machine-readable medium of claim 15, wherein obtaining the validated location data comprises:
obtaining, by the management controller and via the out-of-band communication channel, first location data for the data processing system;
performing, by the management controller, a comparison process using the first location data and second location data to determine whether the first location data is consistent with the second location data, the second location data being a different type of data than the first location data;
in a first instance of the comparison process in which the first location data is determined to be consistent with the second location data:
obtaining, by the management controller and using at least a private key of a public private key pair, the validated location data based on the first location data and the second location data.

17. A data processing system, comprising:
a processor; and
a memory coupled to the processor to store instructions, which when executed by the processor, cause the processor to perform operations for managing operations of a data processing system, the data processing system comprising hardware resources and a management controller that operates independently from the hardware resources and the operations comprising:
obtaining a location log, by a management controller of the data processing system and via out-of-band communication channel of the data processing system, the location log indicating validated location data for the data processing system obtained over a period of time;
generating a location report, by the management controller and using the location log, the location report indicating geographical locations at different points in time of the data processing system; and
providing, by the management controller and via the out-of-band communication channel, the location report to an external device usable to verify whether the data processing system is following an expected path.

18. The data processing system of claim 17, wherein the external device is a server capable of determining whether the data processing system is following an expected path of one or more expected paths, the expected path indicating a sequence of geographical locations and a duration of time over which the data processing system traverses the expected path to be considered normal.

19. The data processing system of claim 17, wherein the external device is a user device that uses the location report to determine whether the geographical locations indicated by the location report are consistent with an external report generated by a user of the data processing system, the external report being considered normal.

20. The data processing system of claim 19, wherein obtaining the location log comprises:
obtaining, by the management controller and via the out-of-band communication channel, the validated location data for the data processing system at different points in time; and
generating the location log using the validated location data.
